(19) United States
(12) Patent Application Publication
(10) Pub. No.: US 2016/0098633 A1
(43) Pub. Date: Apr. 7, 2016

(54) DEEP LEARNING MODEL FOR STRUCTURED OUTPUTS WITH HIGH-ORDER INTERACTION

(71) Applicant: NEC Laboratories America, Inc., Princeton, NJ (US)

(72) Inventor: Renqiang Min, Princeton, NJ (US)

(21) Appl. No.: 14/844,520

(22) Filed: Sep. 3, 2015

Related U.S. Application Data
(60) Provisional application No. 62/058,700, filed on Oct. 2, 2014.

(51) Int. Cl. G06N 3/08

(52) U.S. Cl. CPC G06N 3/084

(57) ABSTRACT

Methods and systems for training a neural network include pre-training a bi-linear, tensor-based network, separately pre-training an auto-encoder, and training the bi-linear, tensor-based network and auto-encoder jointly. Pre-training the bi-linear, tensor-based network includes calculating high-order interactions between an input and a transformation to determine a preliminary network output and minimizing a loss function to pre-train network parameters. Pre-training the auto-encoder includes calculating high-order interactions of a corrupted real network output, determining an auto-encoder output using high-order interactions of the corrupted real network output, and minimizing a loss function to pre-train auto-encoder parameters.

### RELATED APPLICATION INFORMATION

This application claims priority to provisional application 62/058,700, filed Oct. 2, 2014, the contents thereof being incorporated herein by reference.

### BACKGROUND OF THE INVENTION

There are many real-world problems that entail the modeling of high-order interactions among inputs and outputs of a function. An example of such a problem is the reconstruction of a three-dimensional image for a missing human body part from other known body parts. The estimate of each physical measurement of, e.g., the head, including for example the circumference of neck base, is not solely dependent on the input torso measurements but also the measurements in the output space such as, e.g., the breadth of the head. In particular, such measurements have intrinsic high-order dependencies. For example, the person's neck base circumference may strongly correlate with the multiplicity of his or her head breadth and head width. Problems of predicting structured output span a wide range of fields including, for example, natural language understanding (syntactic parsing), speech processing (automatic transcription), bioinformatics (enzyme function prediction), and computer vision.

Structured learning or prediction has been approached with different models, including graphical models and large margin-based approaches. More recent efforts on structured prediction include generative probabilistic models such as conditional restricted Boltzmann machines. For structure output regression problems, continuous conditional random fields have been successfully developed. However, a property shared by most of the existing approaches is that they make explicit and exploit certain structures in the output spaces.

### BRIEF SUMMARY OF THE INVENTION

A method of training a neural network includes pre-training a bi-linear, tensor-based network, separately pre-training an auto-encoder, and training the bi-linear, tensor-based network and auto-encoder jointly. Pre-training the bi-linear, tensor-based network includes calculating high-order interactions between an input and a transformation to determine a preliminary network output and minimizing a loss function to pre-train network parameters. Pre-training the auto-encoder includes calculating high-order interactions of a corrupted real network output, determining an auto-encoder output using high-order interactions of the corrupted real network output, and minimizing a loss function to pre-train auto-encoder parameters.

A system for training a neural network includes a pre-training module, comprising a processor, configured to separately pre-train a bi-linear, tensor-based network, and to pre-train an auto-encoder to reconstruct true labels from corrupted real network outputs. A training module is configured to jointly train the bi-linear, tensor-based network and the auto-encoder.

### BRIEF DESCRIPTION OF THE DRAWINGS

FIG. 1 is a diagram of an artificial neural network in accordance with the present principles.

FIG. 2 is a block/flow diagram of a method for pre-training a bi-linear tensor-based network in accordance with the present principles.

FIG. 3 is a block/flow diagram of a method for pre-training an auto-encoder in accordance with the present principles.

FIG. 4 is a block/flow diagram of jointly training the bi-linear tensor-based network and the auto-encoder in accordance with the present principles.

FIG. 5 is a block diagram of a deep learning system in accordance with the present principles.

### DETAILED DESCRIPTION

Embodiments of the present invention construct non-linear functional mapping from high-order structured input to high-order structured output. To accomplish this, discriminative pretraining is employed to guide a high-order auto-encoder to recover correlations in the predicted multiple outputs, thereby leveraging the layers below to capture high-order input structures with bilinear tensor products and leveraging the layers above to model the interdependency among outputs. The deep learning framework effectively captures the interdependencies in the output without explicitly assuming the topologies and forms of such interdependencies, while the model de facto considers interactions among the input. The mapping from input to output is integrated in the same framework with joint learning and inference.

A high-order, denoising auto-encoder in a tensor neural network constrains the high-order interplays among outputs, which excludes the need to explicitly assume the forms and topologies of the interdependencies among outputs, while leveraging discriminative pretraining guides different layers of the network to capture different types of interactions. The lower and upper layers of the network implicitly focus on modeling interactions among input and output respectively, while the middle layer constructs a mapping between them accordingly.

To accomplish this, the present embodiments employ a non-linear mapping from structured input to structured output that includes three complementary components in a high-order neural network. Specifically, given a D×N input matrix [X₁, . . . , X_{D}]^{T} and a D×M output matrix [Y₁, . . . , Y_{D}]^{T}, a model is constructed for the underlying mapping f between the inputs X_{d} ∈ [symbol] ^{N} and the outputs Y_{d} ∈ [symbol] ^{M}.

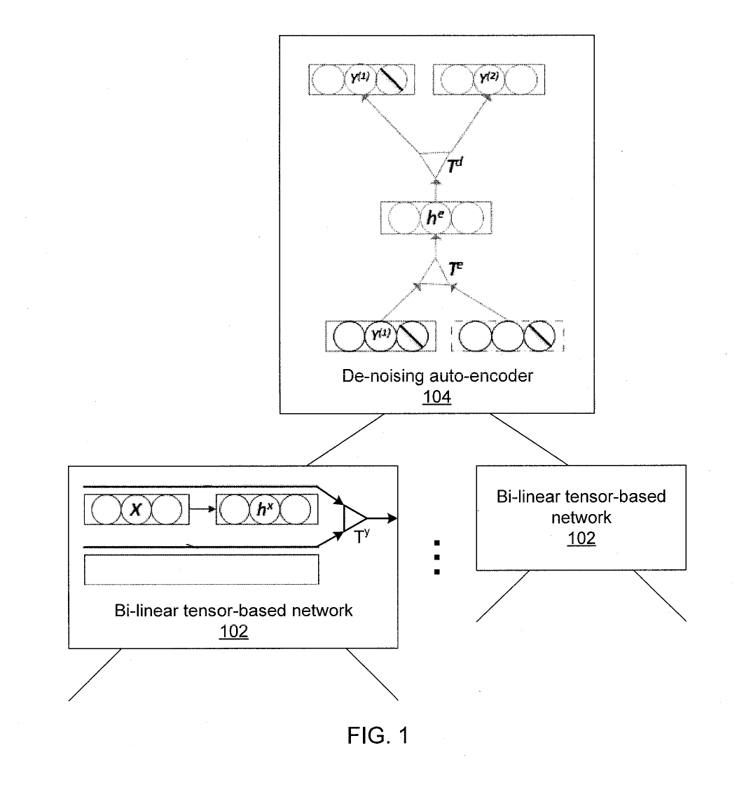

Referring now to FIG. 1, an implementation of a high-order neural network with structured output is shown. The top layer network is a high-order de-noising auto-encoder 104. The auto-encoder 104 is used to de-noise a predicted output y⁽¹⁾ resulting from lower layers 102 to enforce the interplays among the output. During training, a portion (e.g., about 10%) of the true labels (referred to herein as “gold labels”) are corrupted. The perturbed data is fed to the auto-encoder 104. Hidden unit activations of the auto-encoder 104 are first calculated by combining two versions of the corrupted gold labels using a tensor T^{e} to capture their multiplicative interactions. The hidden layer is then used to gate the top tensor T^{d} to recover the true labels from the perturbed gold labels. The corrupted data forces the auto-encoder 104 to reconstruct the true labels, in which the tensors and the hidden layer encode covariance patterns among the output during reconstruction. This can be understood by considering structured output with three correlated targets, y₁, y₂, y₃, and an extreme case in which the auto-encoder 104 is trained using data that always has y₃ corrupted. To properly reconstruct the uncorrupted labels y₁, y₂, y₃ to minimize the cost function, the auto-encoder 104 is forced to learn a function y₃=f(y₁, y₂). In this way, the resulting auto-encoder 104 is able to constrain and recover the structures among the output.

High-order features, such as multiplications of variables, can better represent real-valued data and can be readily modeled by third-order tensors. The bi-linear tensor-based networks 102 multiplicatively relate input vectors, in which third order tensors accumulate evidence from a set of quadratic functions of the input vectors. In particular, each input vector is a concatenation of two vectors: the input unit X ∈ [symbol] ^{N} (with subscript omitted for simplicity) and its non-linear, first order projected vector h(X). The model explores the high-order multiplicative interplays not just among X but also in the non-linear projected vector h(X). It should be noted that the nonlinear transformation function can be any user-defined nonlinear function.

This tensor-based network structure can be extended m times to provide a deep, high-order neural network. Each section 102 of the network takes two inputs, which may in turn be the outputs of a previous section 102 of the network. In each layer, gold output labels are used to train the layer to predict the output. Layers above focus on capturing output structures, while layers below focus on input structures. The auto-encoder 104 then aims at encoding complex interaction patterns among the output. When the distribution of the input to the auto-encoder 104 is similar to that of the true labels, it makes more sense for the auto-encoder 104 to use both the learned coder vector and the input vector to reconstruct the outputs. Fine-tuning is performed to simultaneously optimize all the parameters of the multiple layers. Unlike the layer-by-layer pretraining, uncorrupted outputs from a second layer are used as the input to the auto-encoder 104.

The sections 102 of the high-order neural network first calculate quadratic interactions among the input and its nonlinear transformation. In particular, each section 102 first computes the hidden vector from the provided input X. For simplicity, a standard linear neural network layer is used, with weight W^{x} and bias term b^{x}, followed by a transformation. In one example, the transformation is:

h^{x}=tan h(W^{x}X+b^{x})

where

$$tanh ( z ) = \frac{{e}^{x} - {e}^{- x}}{{e}^{x} + {e}^{- x}} .$$

It should be noted that any appropriate nonlinear transformation function can be used. Next, the first layer outputs are calculated as:

$${Y}^{( 0 )} = tanh ( {[ \begin{matrix}X \\ {h}^{x}\end{matrix} ]}^{T} {T}^{x} [ \begin{matrix}X \\ {h}^{x}\end{matrix} ] + {W}^{( 0 )} [ \begin{matrix}X \\ {h}^{x}\end{matrix} ] + {b}^{( 0 )} )$$

The term

$${W}^{( 0 )} [ \begin{matrix}X \\ {h}^{x}\end{matrix} ] + {b}^{( 0 )}$$

is similar to a standard linear neural network layer. The addition term is a bilinear tensor product with a third-order tensor T^{x}. The tensor relates two vectors, each concatenating the input unit X with the learned hidden vector h^{x}. The concatenation here aims to enable the three-way tensor to better capture the multiplicative interplays among the input.

The computation for a second hidden layer is similar to that of the first hidden layer. The input X is simply replaced with a new input Y⁽⁰⁾, namely the output vector of the first hidden layer, as follows:

$${h}^{y} = tanh ( {W}^{y} {Y}^{( 0 )} + {b}^{y} )$$

$${Y}^{( 1 )} = tanh ( {[ \begin{matrix}{Y}^{( 0 )} \\ {h}^{y}\end{matrix} ]}^{T} {T}^{y} [ \begin{matrix}{Y}^{( 0 )} \\ {h}^{y}\end{matrix} ] + {W}^{( 1 )} [ \begin{matrix}{Y}^{( 0 )} \\ {h}^{y}\end{matrix} ] + {b}^{( 1 )}$$

As illustrated in FIG. 1, the top layer of the network employs a de-noising auto-encoder 104 to model complex covariance structure within the outputs. In learning, the auto-encoder 104 takes two copies of the input, namely Y⁽¹⁾, and feeds the pair-wise products into the hidden tensor (namely the encoding tensor T^{e}):

h^{e}=tan h([Y⁽¹⁾]^{T}T^{e}[Y⁽¹⁾])

Next, a hidden decoding tensor T^{d} is used to multiplicatively combine h^{e} with the input vector Y⁽¹⁾ to reconstruct the final output Y⁽²⁾. Through minimizing the reconstruction error, the hidden tensors are forced to learn the covariance patterns within the final output Y⁽²⁾:

Y⁽²⁾=tan h([Y⁽¹⁾]^{T}T^{d}[h^{e}])

An auto-encoder 104 with tied parameters may be used for simplicity, where the same tensor is used for T^{e} and T^{d}. In addition, de-noising is applied to prevent an overcomplete hidden layer from learning the trivial identity mapping between the input and output. In de-noising, two copies of the inputs are corrupted independently.

All model parameters can be learned by, e.g., gradient-based optimization. Consider the set of parameters: θ={h^{x}, h^{y}, W^{x}, W⁽⁰⁾, W^{y}, W⁽¹⁾, b^{x}, b⁽⁰⁾, b^{y}, b⁽¹⁾, T^{x}, T^{y}, T^{e}. The sum-squared loss error between the output vector on the top layer and the true label vector is minimized over all input instances (Xᵢ, Yᵢ) as follows:

$$𝓁 ( θ ) = {\sum }_{i = 1}^{N} {E}_{i} ( {X}_{i} , {Y}_{i} ; θ ) + γ {‖ θ ‖}_{2}^{2}$$

where sum-squared loss is calculated as:

$${E}_{i} = \frac{1}{2} {\sum }_{j} {( {y}_{j}^{( 2 )} - {y}_{j} )}^{2}$$

Here yⱼ⁽²⁾ and yⱼ are the j-th element in Y⁽²⁾ and Yᵢ respectively. Standard L₂ regularization for all parameters is used, weighted by the hyperparameter λ. The model is trained by taking derivatives with respect to the thirteen groups of parameters in θ.

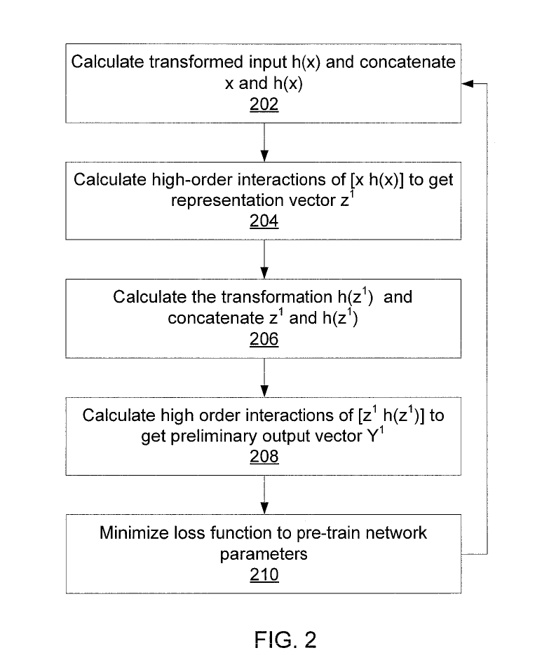

Referring now to FIG. 2, a method of implementing the bi-linear tensor-based networks 102 is shown. Block 202 calculates a transformed input h(x) using a user-defined nonlinear function h( ) and an input vector x. Block 202 then concatenates the input with the transformed input to produce a vector [x h(x)]. Block 204 calculates high-order interactions of [x h(x)] to get a representation vector z¹. Block 206 calculates the transformation of the representation vector as h(z¹) and concatenates the output with the representation vector to obtain the vector [z¹ h(z¹)]. Block 208 calculates high-order interactions in the vector [z¹ h(z¹)] to obtain a preliminary output vector Y¹, and block 210 minimizes a user-defined loss function that involves target labels of the input x and Y¹ to pre-train network parameters. This process repeats until training is complete.

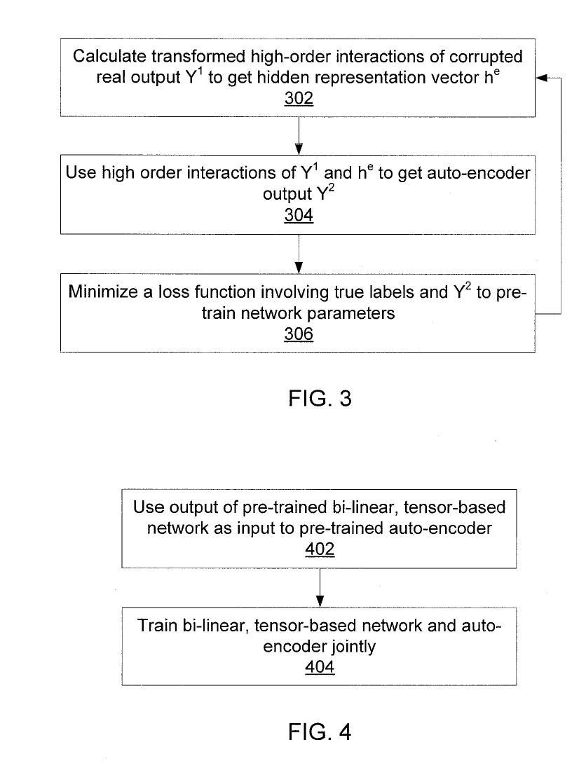

Referring now to FIG. 3, a method of implementing the auto-encoder 104 is shown. Block 302 calculates transformed, high-order interactions of a corrupted real output Y¹ to get a hidden representation vector h^{e}. Block 304 uses high-order interactions of Y¹ and h^{e} to find the output of the auto-encoder 104, Y². Block 306 minimizes a user-defined loss function involving the true labels and Y² to pre-train network parameters. This process repeats until training is complete.

Referring now to FIG. 4, a method for forming a model with the pre-trained network 102 and auto-encoder 104 is shown. Block 402 applies the output of the pre-trained, bi-linear, tensor-based network 102 (Y¹) as the input to the auto-encoder 104. Block 402 trains the network 102 and the auto-encoder 104 jointly, using back-propagation to learn network parameters for both the network 102 and the auto-encoder 104. This produces a trained, unified network.

It should be understood that embodiments described herein may be entirely hardware, entirely software or including both hardware and software elements. In a preferred embodiment, the present invention is implemented in hardware and software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

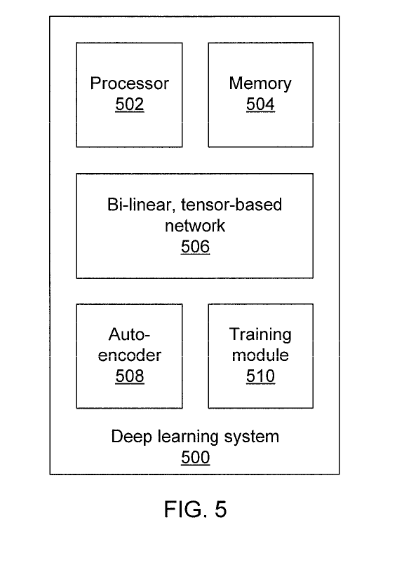

Referring now to FIG. 5, a deep learning system 500 is shown. The system 500 includes a hardware processor 502 and a memory 504. One or more modules may be executed as software on the processor 502 or, alternatively, may be implemented using dedicated hardware such as an application-specific integrated chip or field-programmable gate array. A bi-linear, tensor-based network 506 processes data inputs while a de-noising auto-encoder de-noises the output of the network 506 to enforce interplays among the output. A pre-training module 510 pre-trains the network 506 and the auto-encoder 508 separately, as discussed above, while training module 512 trains the pre-trained network 506 and auto-encoder 508 jointly.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. Additional information is provided in Appendix A to the application. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A method of training a neural network, comprising:
pre-training a bi-linear, tensor-based network by:
calculating high-order interactions between an input and a transformation to determine a preliminary network output; and
minimizing a loss function to pre-train network parameters;
separately pre-training an auto-encoder by:
calculating high-order interactions of a corrupted real network output;
determining an auto-encoder output using high-order interactions of the corrupted real network output; and
minimizing a loss function to pre-train auto-encoder parameters; and
training the bi-linear, tensor based network and auto-encoder jointly.

2. The method of claim 1, wherein pre-training the bi-linear, tensor-based network further comprises:
applying a nonlinear transformation to an input;
calculating high-order interactions between the input and the transformed input to determine a representation vector;
applying the non-linear transformation to the representation vector; and
calculating high-order interactions between the representation vector and the transformed representation vector to determine a preliminary output.

3. The method of claim 1, further comprising perturbing a portion of training data to produce the corrupted real network output.

4. The method of claim 1, wherein minimizing the loss function comprises gradient-based optimization.

5. The method of claim 1, wherein determining the auto-encoder output comprises reconstructing true labels from the corrupted real network output.

6. A system for training a neural network, comprising:
a pre-training module, comprising a processor, configured to separately pre-train a bi-linear, tensor-based network, and to pre-train an auto-encoder to reconstruct true labels from corrupted real network outputs; and
a training module configured to jointly train the bi-linear, tensor-based network and the auto-encoder.

7. The system of claim 6, wherein the pre-training module is further configured to calculate high-order interactions between an input and a transformation to determine a preliminary network output, and to minimize a loss function to pre-train network parameters to pre-train the bi-linear, tensor-based network.

8. The system of claim 7, wherein the pre-training module is further configured to apply a nonlinear transformation to an input, to calculate high-order interactions between the input and the transformed input to determine a representation vector, to apply the non-linear transformation to the representation vector, and to calculate high-order interactions between the representation vector and the transformed representation vector to determine a preliminary output.

9. The system of claim 7, wherein the pre-training module is further configured to use gradient-based optimization to minimize the loss function.

10. The system of claim 6, wherein the pre-training module is further configured to calculate high-order interactions of a corrupted real network output, to determine an auto-encoder output using high-order interactions of the corrupted real network output, and to minimize a loss function to pre-train auto-encoder parameters.

11. The system of claim 6, wherein the pre-training module is further configured to perturb a portion of training data to produce the corrupted real network output.
